(19) United States
(12) Patent Application Publication
(10) Pub. No.: US 2011/0099229 A1
(43) Pub. Date: Apr. 28, 2011

(54) Method for Collaborative Processes Executed among Communities

(76) Inventor: YPaul Chang, Portland, OR (US)

(21) Appl. No.: 12/978,543

(22) Filed: Dec. 25, 2010

Related U.S. Application Data
(63) Continuation-in-part of application No. 12/061,986, filed on Apr. 3, 2008.

(51) Int. Cl. G06F 15/16

(52) U.S. Cl. 709/205; 709/245

(57) ABSTRACT

A method is presented to enable process oriented transactions to take place between community partners across multiple communities, where closed related objects form communities and communities are linked to conduct collaborative work. Transactions are arranged in logical sequences and represented in cross-community URL calling strings which are executed collaboratively among the involving community members. The method includes requesting community members in charge of constructing function trees constituting business processes using logical operators and operational directives, common global process identification, and the receiving addressable objects. Function trees are formed to carry out certain community activities and functions are distributed to the corresponding members from roots to leaves and executed from leaves to root. The common global process identification provides a linkage for the transactions executed in the context of function trees as a systematic unit of work among community partners.

### CROSS-REFERENCE TO RELATED APPLICATIONS

The present continuation-in-part patent application claims priority benefit of the U.S. nonprovisional patent application Ser. No. 12/061,986 filed on Apr. 3, 2008 under 35 U.S.C. 120, which is hereby incorporated by reference for all purposes to the extent that such subject matter is not inconsistent herewith or limiting hereof.

### FIELD OF THE INVENTION

The present invention relates generally to define a framework for coordinating transactions to take place between community partner in a collaborative community environment where closed related objects form communities and communities are linked to conduct collaborative work. More particularly, the invention relates to a method of locating cross-community addressable objects and arranging said addressable objects to interact with each other via function calls or as the parameters of said functions into function trees by means of execution logic controls, execution sequences and reference of common process identification so that collaborative business processes between community partner in collaborative communities can be conducted in a more consistent, secured, and effective manner.

### BACKGROUND OF THE INVENTION

Traditionally, closely related business activities involving multiple transactions and multiple community partners require conciliation efforts in order to link these uncoordinated discrete activities together. Moreover, it is difficult to pinpoint to the problem areas when things go wrong during the execution of activities. A transaction taken place either online or in batch always carries out only one discrete action. For example, a traditional browser URL can only address one domain and one object. To complete a business activity involving multiple transactions and community partners, multiple but uncoordinated individual calls are needed. Operational errors and resource waste could be resulted from these uncoordinated and unstructured calls. Calls are dynamically routed across the network, which increases the risks of vicious packet redirection and interception.

In order to enhance the current online transaction behavior and avoid pitfalls, we need a system that can carry out a series of related actions across multiple community partners in a single call where the logical orders the actions to be executed can be programmatically controlled and the inter-community paths that packages travel can be pre-determined to increase coherence and integrity of transactions and reduce security risks.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary flow to construct an inter-community address sequence using multiple notations and an example of locating a service item in an integrated collaborative ecommerce system comprising multiple communities.

Unless otherwise indicated illustrations in the figures are not necessarily drawn to scale.

### SUMMARY OF THE INVENTION

To achieve the forgoing and other objects and in accordance with the purpose of the invention, a method, system, and program for integrating disjoined but related network components into collaborative communities is presented.

In one embodiment, a system for constructing an inter-community address sequence using multiple notations in an integrated collaborative computing environment. Using multiple notations not only distinguish different addressable object among multiple communities but also correlate these communities together to form a globally unique addresses for the object, based on the community relationship.

In another embodiment, a system for constructing a calling URL string consists of multiple community addressable functions linked by logical operations and operational directives to represent a process where each function contains parameters such as but not limited to originating addressable objects, destination addressable objects, process identifications, and a pre-determined inter-community path.

In another embodiment, the invention provides a method to define collaborative processes by building function trees consisting of a set of functions to carry out particular activities, distributing functions to the corresponding community member, through the pre-determined inter-community paths if specified, and executing functions by the corresponding community members collaboratively in a pre-determined order to complete collaborative processes across communities.

Other features, advantages, and objectives of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

The preferred embodiment of the present invention provides an address locating system to describe an address structure in an integrated collaborative system as a multiple dimension scheme: the first dimension represented by the X axis as a sequence of different notations in an address sequence as a vertical dimension, the second dimension represented by the Y axis as a set of IDs of the same notation as a horizontal dimension, and the third dimension represented by the Z axis as a set of escape IDs starting with an escape notation for an ID along the X axis and the Y axis it describes.

An addressable element can be represented simply with an ID and a destination code or a starting notation specifying the start of address sequence followed by a plurality of IDs where a new notation indicates the start of new section in an address sequence, and an escape notation indicates the start of a section of IDs that is internal or supplemental to the ID it describes.

Different notations that make up an address scheme provide important contexts and meanings to programs that process the address. They represent the boundaries of communities in the network where each community may have different ways of interpreting the set of addresses that belong to it.

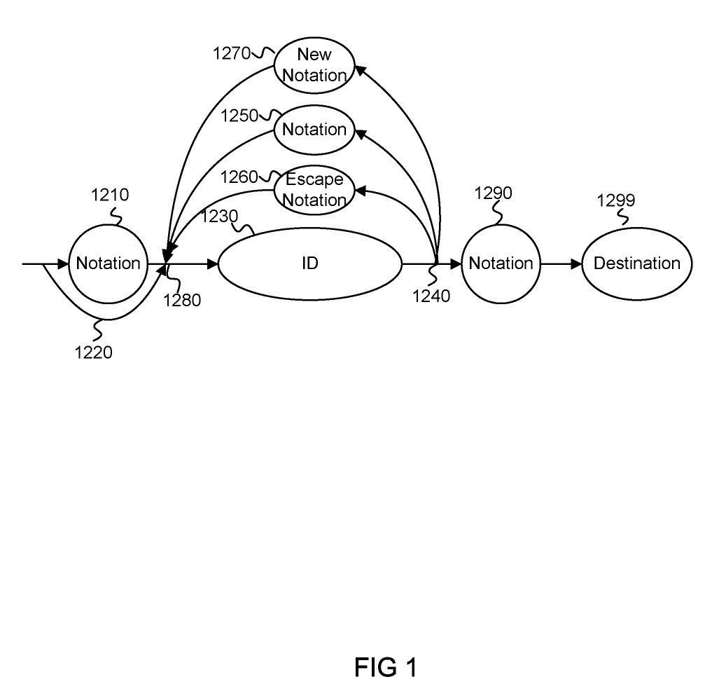

The Multi-Notation Address Locator is to locate every addressable object in the network, such as, but not limited to community objects: computers, users, executable programs, services or merchants items. Each notation used represents a segment within a network. Using multiple notations not only distinguishes different addressable objects among multiple communities but also brings these communities together to form a globally unique address for the objects based on the community relationship, as illustrated in FIG. 1.

FIG. 1 illustrates an exemplary flow to construct an inter-community address sequence using multiple notations. In the present embodiment, the flow starts with the first notation 1210 indicating the highest level of network architecture, followed by an ID 1230 indicating the first addressable identification in the sequence in order to locate the destination. The leading notation may be omitted by the link 1220. If there is more than one addressable object need to be traversed within the same community in order to get to the destination, the repeating point 1240 directs the flow to insert the notation 1250 of the same community into the sequence. The flow is forwarded at the point 1280 to include the next addressable identification 1230 in to the sequence. Therefore a plurality of IDs 1230 in the same community can be listed in the sequence until the next community is crosses by adopting a new notation 1270. The same flow mentioned above will be repeated for each new community needed to be traversed in order to get to the destination. For each addressable identification listed in the sequence, sometimes additional information is needed to assist the system which parses and executes the locating process; the escape notation 1260 is used for that purpose. Therefore a plurality of supplemental IDs for the same addressable object can be listed in the sequence until the next addressable object is encountered. When all the addressable objects are listed in the sequence in order to locate the destination, the final notation 1290 of which the destination object belongs is inserted into the sequence and finally finished by specifying the destination identification 1299 in the address sequence.

Those skilled in the art will readily recognize, in accordance with the teachings of the present invention, that any of the foregoing steps and/or system modules may be suitably replaced, reordered, removed and additional steps and/or system modules may be inserted depending on the needs of the particular application and that the systems of the foregoing embodiments may be implemented using any of a wide variety of suitable processes and system modules not limited to any particular computer hardware, software, middleware, firmware, microcode and the like.

The preferred embodiment of the present invention provides a method to define collaborative processes by building function trees consisting of a set of functions to carry out particular activities, distributing functions to the corresponding community member, through the pre-determined inter-community paths if specified, and executing functions by the corresponding community members collaboratively in a pre-determined order to complete collaborative processes across communities. A function contains a function name and its parameters including, but not limited to, origination addressable objects, destination addressable objects, pre-determined inter-community paths of addressable objects across multiple communities, common process identification, and nested function calls. Once functions are distributed to the corresponding community members, the parent calling functions wait for their child function calls to be completed. Child functions are executed, more function trees are created and processed by the child functions if needed, and the results of the executions are reported back to the parent function calls. When the root level functions receive all the results from their child function calls, the functions are executed and complete the whole process. The status of each function calls are polled by the parent functions via the common global process identifications within this cross community collaborative process model as integrated and consistent processes.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC §112 (6) it is intended that the corresponding means for and/or steps for carrying out the claimed function also include those embodiments, and equivalents, as contemplated above that implement at least some novel aspects and objects of the present invention in the jurisdiction of the USA.

Having fully described at least one embodiment of the present invention, other equivalent or alternative methods of implementing an integrated and collaborative computing environment according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed:

1. An address locating method for an integrated collaborative network across multiple communities, this method is comprised by:
obtaining a first notation;
indicating a first addressable identification of an addressable object in a sequence for a destination address of a destination object;
if additional addressable objects are required to be traversed in a first community, indicating said first notation and additional addressable identifications of said addressable objects in said sequence, each of said additional addressable identifications concatenated by said first notation;
obtaining a second notation; and
if additional addressable objects are required to be traversed in a second community, indicating said second notation and indicating said additional addressable identifications of said addressable objects in said sequence, each of said additional addressable identifications concatenated by said second notation;
indicating said second notation in said sequence; and
repeating the steps of obtaining a new notation, indicating said new notation, and indicating said additional addressable identifications of said addressable objects in the said sequence, each of said additional addressable identification concatenated by said new notation, for every community required to be traversed;
indicating said new notation in said sequence; and
indicating a addressable identification of said destination address in said sequence completing said sequence for said destination address of said destination object.

2. The method as recited in claim 1, wherein said notations denote the boundaries of said communities.

3. The method as recited in claim 1, wherein addressable identifications of addressable objects of the same community are concatenated using the same notation.

4. The method as recited in claim 1, wherein a supplemental address sequence can be inserted into said sequence to describe said addressable identification it follows.

5. A method to define a process based URL consists of multiple functions located across multiple communities where each function contains a function name with parameters including but not limited to origination addressable objects, destination addressable objects, pre-determined inter-community paths of addressable objects across multiple communities, common process identifications, and nested functions.

6. The method as recited in claim 5, wherein logical operations such as but not limited to AND, OR, and NOT, execution directives such as but not limited to Parallel, Sequential, Query, Loop, Map, and IF, and communication protocols such as but not limited to HTTP, SNMP, and FTP, are used to arrange the sequences of execution flows of functions listed in the URL.

7. A method to implement a process based URL by building function trees consisting of a set of functions to carry out particular activities, distributing functions to the corresponding community members, and executing functions by the corresponding community members collaboratively to complete collaborative processes across communities, with the steps of:
requesting community members compiling function trees and assigning parameters such as but not limited to the originating members, destination members, and common global process identifications to each function;
distributing functions to the corresponding members by traversing the function trees from roots as the lowest levels to leaves as the top levels where lower level members forward sub-tree functions which are above their current levels to the next higher level members listed as originating members at the first level functions of the sub-trees, and then wait for the completion of their higher level function executions;
upper function level members executing their functions, creating more child function trees using the same processes of this claim, if needed, and reporting the execution results to the next lower function level members; and finally root function level members executing their functions and completing the collaborative processes;
